(19) United States
(12) Patent Application Publication
(10) Pub. No.: US 2014/0378067 A1
(43) Pub. Date: Dec. 25, 2014

(54) COMMUNICATION INFRASTRUCTURE INTERFERENCE DETECTION

(71) Applicant: T-Mobile USA, Inc., Bellevue, WA (US)

(72) Inventor: Chad AU, Kirkland, WA (US)

(21) Appl. No.: 13/925,805

(22) Filed: Jun. 24, 2013

(51) Int. Cl. H04W 24/08

(52) U.S. Cl. CPC H04W 24/08
USPC 455/67.11

(57) ABSTRACT

Systems, methods and procedures are described for detecting passive intermodulation (PIM) associated with wireless communication devices and infrastructure. In one implementation, equipment and functionalities associated with a wireless communication system are used to detect PIM. In a particular implementation, PIM is detected using one or more components integral to a base station transceiver. The PIM may be communicated to other wireless communication elements for evaluation.

### BACKGROUND

Intermodulation interference is an unwanted radio frequency (RF) signal or signals generated by the non-linear mixing of two or more frequencies in a passive device such as a connector or cable. Intermodulation interference caused by a passive device is also known as passive intermodulation (PIM). PIM is as a problem for cellular telephone technologies such as Global System for Mobile Communications (GSM), Advanced Wireless Service (AWS), Long Term Evolution (LTE) and Personal Communication Service (PCS) systems. Cable assemblies connecting a base station to an antenna system on a tower or roof top using these cellular systems typically have multiple connectors that cause PIM that can interfere with system operation. PIM-causing non-linear junctions can also exist in the antenna itself, as well as in the vicinity just external to the antenna system, such as metal flashing or HVAC equipment on a rooftop.

The PIM signals are created when two RF signals from different systems mix at a non-linear junction such as a faulty cable connector. If the generated PIM frequency components fall within the receive band of a base station, it can effectively block a channel and make the base station receiver unable to decode a signal that is now corrupted. Generally the PIM components of concern are 3^{rd}, 5^{th} and 7^{th} order where the third order is of greatest signal strength, and therefore, of primary concern. PIM can, thus, occur when two base stations operating at different frequencies, such as a first communication protocol device (e.g., AWS) and a second communication protocol device (e.g., PCS), are in close proximity.

PIM can be reduced and made inconsequential by replacing faulty cables or connectors. Test systems are thus utilized to detect the PIM junctions enabling a technician to locate the faulty cable or connector. The test system to measure PIM, thus, creates signals at two different frequencies, amplifies them, and provides them through cables connecting a base station antenna system on a tower or rooftop. The return PIM signal is filtered which can then be detected. Some of the current test equipment can also determine the distance to the PIM junction, which helps to isolate the faulty hardware for repair or replacement.

Conventional PIM analysis systems generally utilize two signal sources, with a first signal source producing a signal at frequency F1 and the second signal source producing a signal at frequency F2. When these signals are allowed to share the same signal path in a transmission medium, unwanted intermodulation signals can occur when defects with nonlinearities occur. The 3^{rd} order response is particularly troublesome as it produces signals at 2 F1±F2 as well as 2 F2±F1.

A conventional field PIM analysis system is generally embodied in a portable device that must be operated by a technician onsite at a base station or other network infrastructure location. The base station must be disconnected from its antenna system in order for the conventional field PIM analysis system to perform its function.

### BRIEF DESCRIPTION OF THE DRAWINGS

The detailed description is forth with reference to the accompanying figures. In the figures, the left-most digit(s) of a reference number identifies the figure in which the reference number first appears. The use of the same reference numbers in different figures indicates similar or identical items.

For this discussion, the devices and systems illustrated in the figures are shown as having a multiplicity of components. Various implementations of devices and/or systems, as described herein, may include fewer components and remain within the scope of the disclosure. Alternately, other implementations of devices and/or systems may include additional components, or various combinations of the described components, and remain within the scope of the disclosure.

FIG. 1 illustrates an exemplary wireless communication system.

FIG. 2 illustrates a base station which is enabled to transmit and receive data and voice signals, which may be used in the wireless communication system illustrated in FIG. 1.

FIG. 3 shows a block diagram of components of a system setup for measuring passive intermodulation (PIM).

FIG. 4 is an illustrative computing device that may be used to implement exemplary implementations described herein.

FIG. 5 is a flowchart of a process that may be implemented to determine an intermodulation product associated with an element of a communication system.

### DETAILED DESCRIPTION

Systems, methods and procedures are described for detecting passive intermodulation (PIM) associated with wireless communication devices and infrastructure. In one implementation, equipment and functionalities associated with a wireless communication system are used to detect PIM. In a particular implementation, PIM is detected using one or more components integral to a base station transceiver. The PIM may be communicated to other wireless communication elements for evaluation.

Wireless communication device, mobile communication device or user device, as used herein and throughout this disclosure, refers to any electronic device capable of wirelessly sending and receiving data. A mobile device may have a processor, a memory, a transceiver, an input, and an output. Examples of such devices include cellular telephones, personal digital assistants (PDAs), portable computers, etc. The memory stores applications, software, or logic. Examples of processors are computer processors (processing units), microprocessors, digital signal processors, controllers and microcontrollers, etc. Examples of device memories that may comprise logic include RAM (random access memory), flash memories, ROMS (read-only memories), EPROMS (erasable programmable read-only memories), and EEPROMS (electrically erasable programmable read-only memories).

Mobile devices may communicate with each other and with other elements via a network, for instance, a wireless network, or a wireline network. A network may include broadband wide-area networks such as cellular networks, local-area networks (LAN), Wi-Fi, and personal area networks, such as NFC networks including Bluetooth®. Communication across a network may be packet-based; however, radio and frequency/amplitude modulation networks may enable communication between communication devices using appropriate analog-digital-analog converters and other elements. Communication may be enabled by hardware or mixed hardware and software elements called transceivers. Mobile devices may have more than one transceiver, capable of communicating over different networks. For example, a cellular telephone may include a cellular transceiver for communicating with a cellular base station, a Wi-Fi transceiver for communicating with a Wi-Fi network, and a Bluetooth® transceiver for communicating with a Bluetooth® device. A Wi-Fi network is accessible via access points such as wireless routers, etc., that communicate with the Wi-Fi transceiver to send and receive data. The Wi-Fi network may further be connected to the internet or other packet-based networks. The bandwidth of a network connection or an access point is a measure of the rate of data transfer, and can be expressed as a quantity of data transferred per unit of time.

A network typically includes a plurality of elements that host logic or intelligence for performing tasks on the network. The logic can be hosted on servers. In modern packet-based wide-area networks, servers may be placed at several logical points on the network. Servers may further be in communication with databases and can enable communication devices to access the contents of a database. Billing servers, application servers, etc. are examples of such servers. A server may include several network elements, including other servers, and can be logically situation anywhere on a service provider's network, such as the back-end of a cellular network

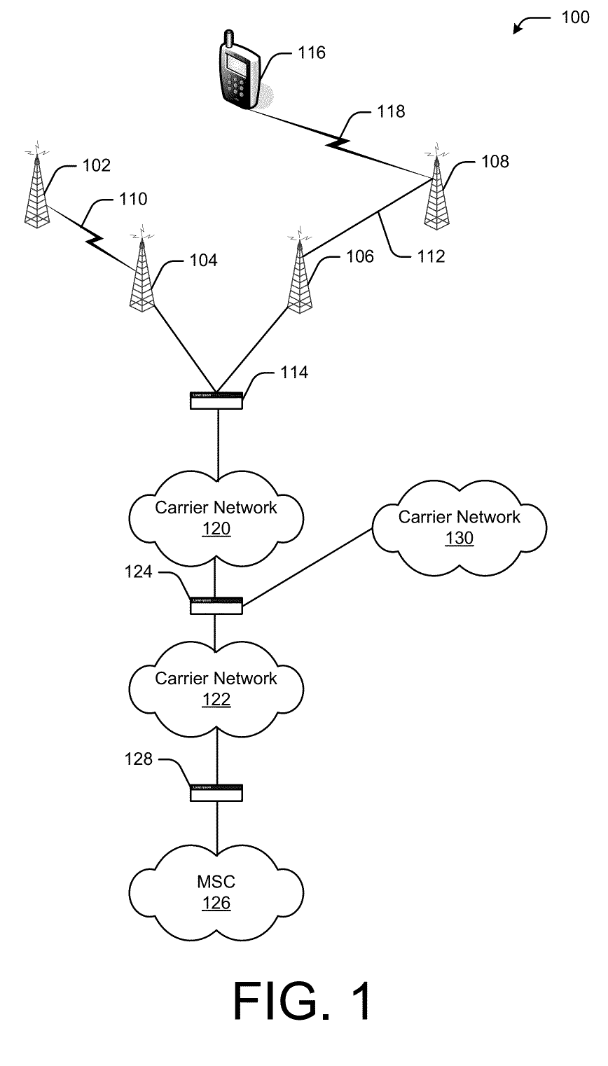

FIG. 1 illustrates an exemplary wireless communication system 100. The wireless system 100 may employ multiple base stations 102, 104, 106 and 108. The base station 102 is shown as being coupled to the base station 104 by way of a wireless communication link 110. The base station 108 is shown as being coupled to the base station 106 using a wire or optical link 112. Each of the base stations 104 and 106 is shown as being coupled to a router 114. The link between the router 114 and the base stations 104 and 106 may be wire or wireless link implemented. A wireless device 116, such as a mobile phone, may be coupled to the base station 108 via wireless signals 118.

A plurality of carrier networks 120 and 122 may be used in the wireless communication system 100. A router 124 may couple the two carrier networks 120 and 122. A mobile switching center (MSC) 126 may be coupled to the carrier network 122 through a router 128. Generally, wired links are used between the router 114 and the MSC 126. However, wireless connectivity may also be used. To enable further expansion of the wireless communication system 100, a further carrier network 130 may be implemented and which is shown as being coupled to the router 124. A plurality of routers (e.g., edge and internal routers) may be implemented within the ‘clouds’ illustrating the carrier networks 120, 122 and 130.

Each of the base stations 102-108 may be assigned a unique ID. The unique ID is primarily used for routing of user traffic and measurement traffic. In particular, in order to support the hand-off from a carrier network (e.g., carrier networks 120, 122, and 130), the wireless communication system 100 may use IEEE 802.1Q protocol to support VLAN ID assignment to each of the base stations 102-108, and use IEEE 802.1P protocol to ensure point-to-point (P2P) class of service for different types of traffic.

In a generic wireless communication system, there may be only a single carrier network that is to route traffic from the MSC to the base stations coupled to the carrier network. In such an arrangement, each base station is regarded as individual access point (AP), which is one wired hop through a router to access the carrier network. In other words, the end-to-end transport connection includes the MSC that receives and sends traffic from the carrier network to a base station (i.e., 1:1:1 traffic routing).

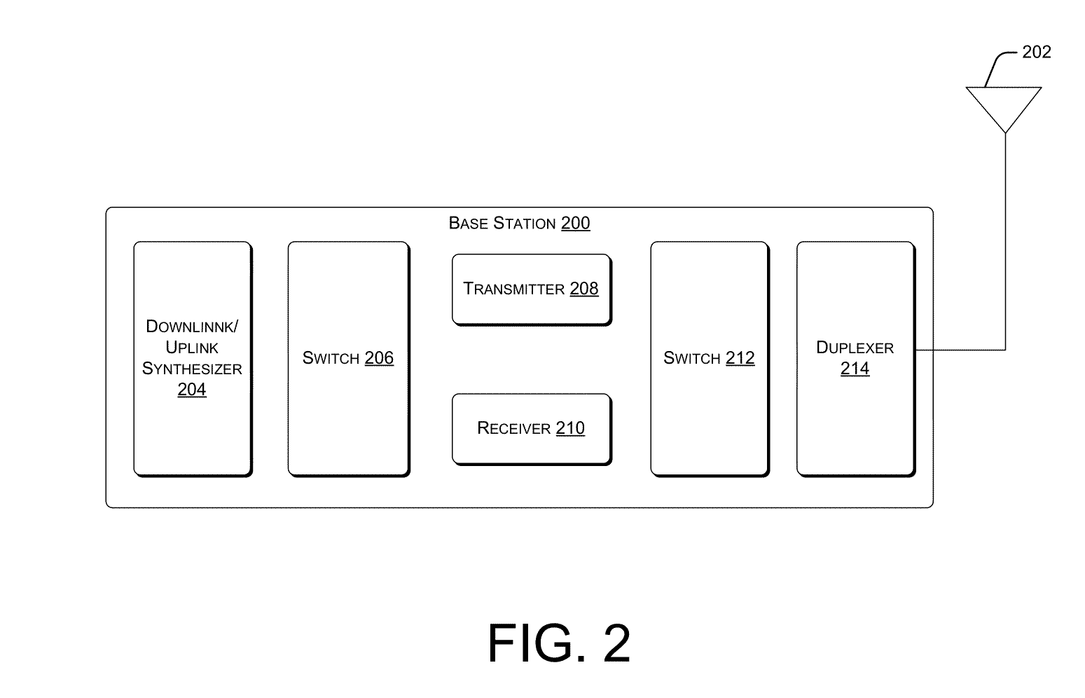

FIG. 2 illustrates a base station 200 which is enabled to transmit and receive data and voice signals. The base station 200 includes an antenna 202 for receiving and transmitting data and/or voice signals. The base station 200 also includes a downlink synthesizer and an uplink synthesizer 204, the downlink synthesizer being tuned to a downlink frequency and the uplink synthesizer being tuned to an uplink frequency

A synthesizer switch 206 is provided enabling the downlink synthesizer to be connected to either the transmitter circuit 208 or the receiver circuit 210 and the uplink synthesizer to be connected to the transmitter circuit 208 or the receiver circuit 210. Thus, the base station 4 can both transmit and receive in either the band of frequencies conventionally assigned to data uplink or the band of frequencies conventionally assigned for data downlink. The transmitter circuit 208 and receiver circuit 210 may each be transceivers.

Further, there is provided a transceiver switch 212 which enables the transmitter 208 to be connected to either the uplink or the downlink port (not shown) of a duplexer 214 in the base station 200 and the receiver 210 to be connected to either the uplink or the downlink port of the duplexer 214.

The duplexer 214 is configured to pass data received at the uplink port to the antenna 202 for transmission in the uplink frequency band, and pass data received at the antenna 202 in the uplink frequency band to the uplink port. Additionally, the duplexer 214 is also configured to pass data to the antenna 202 for transmission in the downlink frequency band and pass data, received at the antenna 202 in the downlink frequency band to the downlink port. By selectively connecting the transmitter circuit 208 or the receiver circuit 210 to the relevant port the transceiver switch 212 allows the base station 200 to receive data or transmit data in either uplink or downlink frequency band.

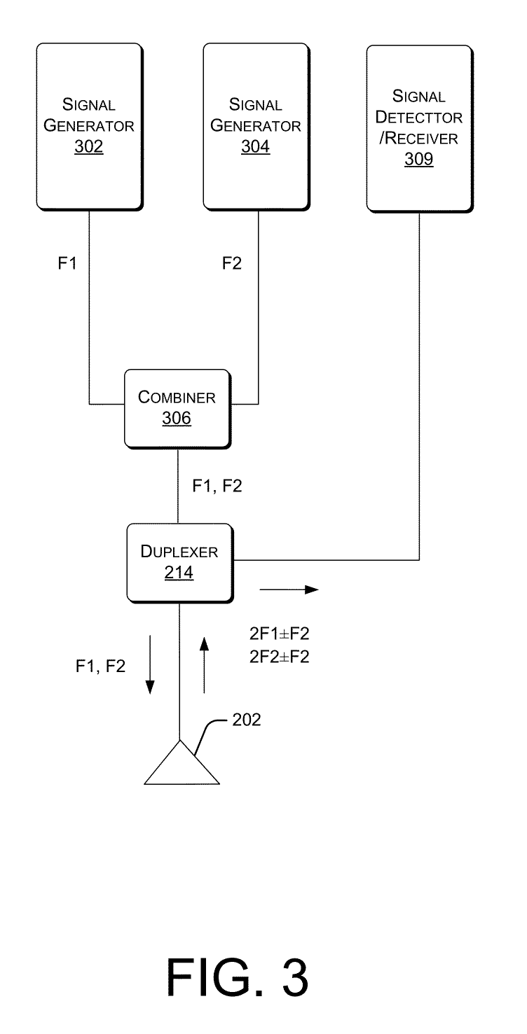

FIG. 3 shows a block diagram of components of a system setup for measuring PIM. The test system utilizes two signal sources 302 and 304, with a first signal source 302 producing a signal at frequency F1 and the second signal source 304 producing a signal at frequency F2. When these multiple signals are allowed to share the same signal path in a nonlinear transmission medium, the unwanted signals can occur. The 3rd order response is particularly troublesome as it produces signals at 2 F1±F2 as well as 2 F2±F1, which is routed through the duplexer to the detector/receiver 309. The illustration of FIG. 3 shows that two sources are used to generate the frequency F1 and the frequency F2, but it is to be understood that the two frequencies may be generated by one or more amplifiers/transceivers of the base station 200. Moreover, it is to be understood that the frequencies F1 and F2 are to be generated by integral operational elements of the base station 200. For example, in one implementation, the frequencies F1 and F2 are generated by one or more of the transmitter 208 and receiver 210 of the base station 200. Therefore, a signal generator external to the base station 200 is not required to generate the frequencies F1 and F2. Furthermore, in one implementation, all the elements illustrated in FIG. 3 are integral parts of the base station 200.

In the system of FIG. 3, the signal sources 302 and 304 are provided to a combiner 306 to create a combined signal with frequencies F1 and F2 at an output of the combiner 306. A duplexer 308 sends the signals F1 and F2 to the antenna 202. A reverse or reflected signal from the antenna 202 is then produced at frequency 2 F1±F2 as well as 2 F2±F1, and forwarded through duplexer 214, via the antenna 302 to the detector/receiver 309. The reverse or reflected signal may also be provided by a different antenna associated with the wireless communication system 100.

Further to the foregoing, in a non-limiting example, the two signals F1 and F2 and how they create a third interfering signal can be explained using an example measurement setup with two distinct transceivers, a first band transmitter 302 transmitting at F1=1930 MHz and an second band transmitter 304 transmitting at F2=2127.5 MHz. The PIM produced signal, which can be the result of reflection from a corroded connector or antenna (e.g., antenna 202) in the transmission path, is simulated by a PIM source attached to the antenna 202. It is unknown where an actual PIM or multiple PIM sources may be located. This can be especially troubling when multiple connectors are involved as can be present in a PCS/AWS/LTE site tower, for example. But, the PIM source in combination with its connecting cable and load can be designed to simulate reflection from at least one connector.

The PIM source generates a signal at 2×1930−2127.5=1732.5 MHz that is in the receive band of the receiver 309. The receive channel of the receiver 309 in an actual operating environment can be desensitized by this interfering signal due to the broadband non-correlated characteristic of the modulation present on both transmit carriers spreading the power over the entire receive channel. Since the desired PIM signal to be measured is the 1732.5 MHz signal, a bandpass filter with center frequency of 1732.5 may be used to filter out other signal components and provide the PIM signal for measurement to a digital receiver or spectrum analyzer, which may be part of the base station 200 and/or one of the carrier networks 120, 122, and 130, and or the MSC 126.

The foregoing provides a very elegant solution for detecting PIM. That is, elements associated with the wireless communication system 100 are used for detecting PIM, rather than the use of an external PIM detector. In a further example, the wireless communication system 100 may use operational elements thereof, such as a computing device 400, to determine a proximity of a PIM junction based on a signal time of travel from one or more signal generators (e.g., signal sources 302 and 304) in a base station (e.g., base station 200) to the point when a receiver (e.g., detector/receiver 309) detects the reflected PIM.

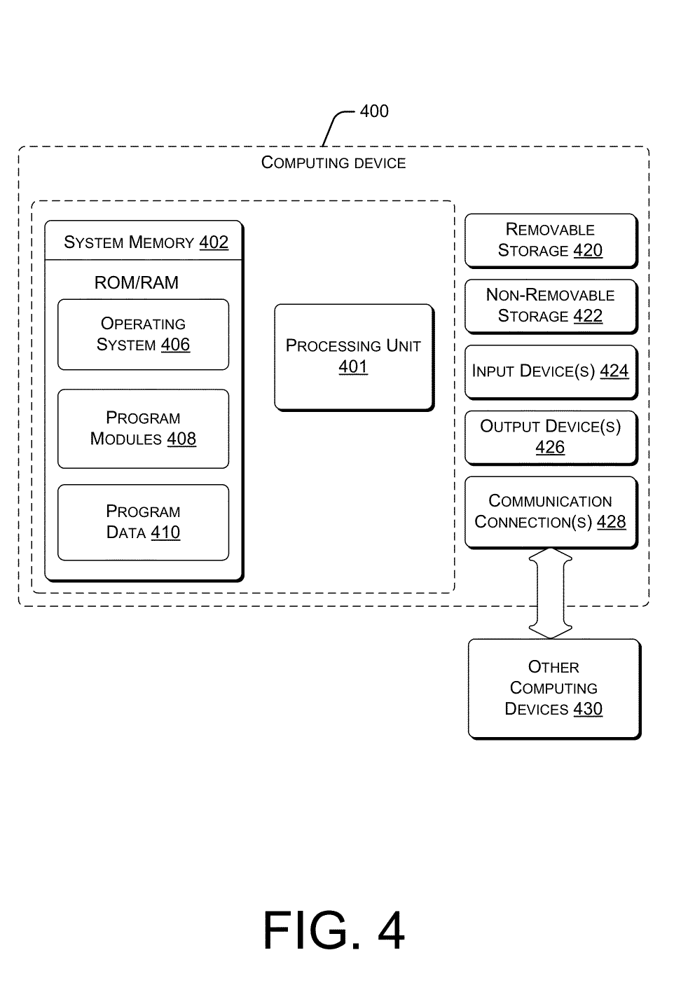

FIG. 4 is an illustrative computing device 400 that may be used to implement exemplary implementations described herein. In particular, the computing device 400 may be used to implement one or more of the elements illustrated in FIGS. 1-3. In a very basic configuration, the computing device 400 includes at least one processing unit 401 and a system memory 402. Depending on the exact configuration and type of the computing device 400, the system memory 402 may be volatile (such as RAM), non-volatile (such as ROM, flash memory, etc.) or some combination of the two. The system memory 402 typically includes an operating system 406, one or more program modules or applications 408, and may include program data 410 in the form of, in one implementation, executable instructions.

The computing device 400 may have additional features or functionality. For example, the computing device 400 may also include additional data storage devices (removable and/or non-removable) such as, for example, magnetic disks, optical disks, or tape. Such additional storage is illustrated in FIG. 400 as a removable storage 420 and a non-removable storage 422. Computer storage media may include volatile and nonvolatile, removable and non-removable media implemented in any method or technology for storage of information, such as computer readable instructions, data structures, program modules, or other data. The system memory 402, removable storage 420 and the non-removable storage 422 are all examples of computer storage media. Thus, computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by the computing device 400. Any such computer storage media may be part of the device 400. The computing device 400 may also have an input device(s) 424 such as keyboard, mouse, pen, voice input device, touch input device, etc. An output device(s) 426 such as a display, speakers, printer, etc. may also be included. These devices are well known in the art and need not be discussed at length.

The computing device 400 may also contain a communication connection 428 that allows the device to communicate with other computing devices 430, such as over a wireless or wireline network (e.g. the Internet). The communication connection(s) 428 is one example of communication media. Communication media may typically be embodied by computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media can be any available media that can be accessed by a computer. By way of example, and not limitation, computer readable media may comprise “computer storage media” and “communications media.”

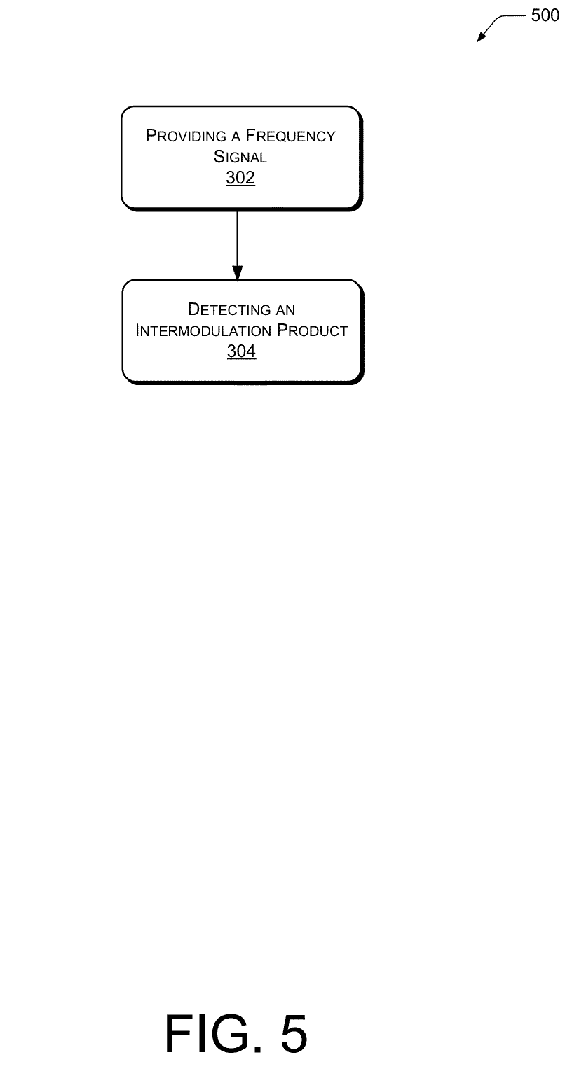

FIG. 5 is a flowchart of a process 500 that may be implemented to determine an intermodulation product associated with an element of a communication system. The process 500 may be executed by any device or entity within a communication system. In one particular implementation, a transceiver, such as one of the signal generators 302 and 304, associated with a base station, such as one of the base stations 102, 104, 106 and 108, executes the process 500. In another particular implementation, a base station, such as one of the base stations 102, 104, 106 and 108, or cluster of base stations executes the process 500.

At act 502, a frequency signal is provided. The frequency signal may be provided by a frequency generator integrated with a base station or at least one of co-located base stations. At act 504, an intermodulation product is detected from a first signal component and a second signal component of the frequency signal.

In the above description of exemplary implementations, for purposes of explanation, specific numbers, materials configurations, and other details are set forth in order to better explain the invention, as claimed. However, it will be apparent to one skilled in the art that the claimed invention may be practiced using different details than the exemplary ones described herein. In other instances, well-known features are omitted or simplified to clarify the description of the exemplary implementations.

The inventors intend the described exemplary implementations to be primarily examples. The inventors do not intend these exemplary implementations to limit the scope of the appended claims. Rather, the inventors have contemplated that the claimed invention might also be embodied and implemented in other ways, in conjunction with other present or future technologies.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts and techniques in a concrete fashion. The term “techniques,” for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more,” unless specified otherwise or clear from context to be directed to a singular form.

The exemplary processes discussed herein may be implemented with hardware, software, firmware, or any combination thereof. In the context of software/firmware, instructions stored on one or more processor-readable storage media that, when executed by one or more processors, may perform the recited operations. The operations of the exemplary processes may be rendered in virtually any programming language or environment including (by way of example and not limitation): C/C++, Fortran, COBOL, PASCAL, assembly language, markup languages (e.g., HTML, SGML, XML, VoXML), and the like, as well as object-oriented environments such as the Common Object Request Broker Architecture (CORBA), Java™ (including J2ME, Java Beans, etc.), Binary Runtime Environment (BREW), and the like.

Processor-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

What is claimed:

1. An apparatus, comprising:
a frequency generator integrated with an element of a communication system, the signal generator configured to provide a frequency signal to an antenna of the communication system; and
an intermodulation detection device integrated with the communication system, the intermodulation detection device configured to detect an intermodulation product from a first signal component and a second signal component of the frequency signal.

2. The apparatus of claim 1, wherein the signal generator is associated with a transceiver of the element of the communication system.

3. The apparatus of claim 1, wherein the signal generator includes a first signal source configured to generate the first signal component, a second signal source configured to generate the second signal component, and a combiner configured to generate the frequency signal by combining the first signal component and the second signal component.

4. The apparatus of claim 1, wherein the element of the communication system is a base station or co-located base stations.

5. The apparatus of claim 1, wherein the frequency generator is a transceiver integrated with the element, the element being a base station.

6. The apparatus of claim 1, further comprising another element of the communication system, the another element to receive the intermodulation product.

7. The apparatus of claim 1, wherein the another element is a mobile switching center.

8. The apparatus of claim 1, wherein intermodulation detection device is a signal detector, the signal detector being integrated with the element of a communication system, the element being a base station or at least one of co-located base stations.

9. The apparatus of claim 1, wherein the intermodulation product is at least one of 2 F1±F2 or 2 F2±F1, F1 being the first signal component and F2 being the second signal component of the frequency signal.

10. A method, comprising:
providing a frequency signal, the frequency signal provided by a frequency generator integrated with a base station or at least one of co-located base stations;
detecting an intermodulation product from a first signal component and a second signal component of the frequency signal.

11. The method of claim 10, wherein the detecting is performed by an intermodulation detection device integrated with the base station or the at least one of the co-located base stations.

12. The method of claim 10, wherein the providing is performed by at least one transceiver integrated with the base station or integrated with the at least one of the co-located base stations.

13. The method of claim 10, further comprising determining a proximity of the intermodulation product based on a time of travel associated with the frequency signal, the time of travel calculated based on a first time observed when the frequency signal is provided and a second time observed when the intermodulation product is detected.

14. The method or claim 10, further comprising providing the intermodulation product to an element of a communication system being external the base station or the at least one of the co-located base stations.

15. The method of claim 14, wherein the element of the communication system is mobile switching center.

16. The method of claim 10, wherein the intermodulation product is at least one of 2 F1±F2 or 2 F2±F1, F1 being the first signal component and F2 being the second signal component of the frequency signal.

17. An apparatus, comprising:
at least one transceiver integrated with a base station, the at least one transceiver having at least two modes of operation, including,
a first mode to transmit and receive signals associated with mobile devices coupled to the transceiver, and
a second mode to provide an intermodulation test frequency signal having a first signal component and a second signal component;
an intermodulation detection device integrated with the base station, the intermodulation detection device configured to detect an intermodulation product from a first signal component and a second signal component of the intermodulation test frequency signal.

18. The apparatus of claim 17, wherein the at least one transceiver is to disable the first mode upon entering the second mode.

19. The apparatus of claim 17, wherein the at least one transceiver includes a first signal source configured to generate the first signal component, a second signal source configured to generate the second signal component, and a combiner configured to generate the intermodulation test frequency signal by combining the first signal component and the second signal component.

20. The apparatus of claim 17, further comprising a mobile switching center to receive the intermodulation product.

21. The apparatus of claim 17, wherein the intermodulation product is at least one of 2 F1±F2 or 2 F2±F1, F1 being the first signal component and F2 being the second signal component of intermodulation test frequency signal.
